(19) United States
(12) Patent Application Publication
(10) Pub. No.: US 2010/0265449 A1
(43) Pub. Date: Oct. 21, 2010

(54) LIQUID CRYSTAL DISPLAY DEVICE

(75) Inventors: Syuuichi KIRA, Tokyo (JP); Masaya Mizunuma, Tokyo (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: MITSUBISHI ELECTRIC CORPORATION, Chiyoda-ku (JP)

(21) Appl. No.: 12/760,052

(22) Filed: Apr. 14, 2010

(30) Foreign Application Priority Data
Apr. 21, 2009 (JP) 2009-102969

(51) Int. Cl. G02F 1/1339

(52) U.S. Cl. 349/153

(57) ABSTRACT

A liquid crystal display device includes a frame-shaped resin BM formed to surround a display area on a counter substrate and having a slit formed in a manner surrounding the display area, a moisture-resistant material formed to fill at least inside of the slit and having a water absorption ratio lower than that of a sealing material, and liquid crystal filled in space formed by a TFT array substrate, the counter substrate, and the sealing material. The sealing material is disposed in a manner being inner than the slit. The sealing material is disposed in a manner extending to an outer end of a portion inner than the slit, of the resin BM, or the moisture-resistant material is disposed in a manner further covering a portion outer than an outer end of the sealing material, of a portion inner than the slit, of the resin BM.

### INCORPORATION BY REFERENCE

This application is based upon and claims the benefit of priority from Japanese patent application No. 2009-102969, filed on Apr. 21, 2009, the disclosure of which is incorporated herein in its entirety by reference.

### BACKGROUND OF THE INVENTION

1. Field of the Invention

The present invention relates to a liquid crystal display device and in particular to a liquid crystal display device using a resin black matrix.

2. Description of Related Art

Liquid crystal display devices include a TFT array substrate having thin film transistors (TFTs) formed in matrix thereon and a counter substrate disposed as opposed to the TFT array substrate. Liquid crystal is sealed in space formed by both substrates and a sealing material bonding together these substrates. The counter substrate is, for example, a color filter substrate on which coloring materials for displaying colors are formed.

In the non-display area (frame area) of the counter substrate, a portion of a frame-shaped black matrix (BM) is disposed in a manner surrounding the display area in order to prevent leakage of light from the backlight. In the past, the black matrix was typically made of chromium oxide. Recently, black matrixes made of a resin (hereafter referred to as “resin BMs”), where a carbon or titanium black pigment is dispersed in a resist, have been widely used, since resin BMs are less costly and less reflective than black matrixes made of chromium oxide.

Unfortunately, liquid crystal display devices using a resin BM are known to have a problem with moisture resistance. Specifically, display unevenness or the like sometimes occurs on the periphery of the display area due to penetration of moisture into the liquid crystal.

With regard to such a moisture-resistant problem, methods for preventing moisture from penetrating due to peel-off of the black matrix are disclosed in, for example, Japanese Unexamined Patent Application Publication Nos. 11-264970 and 2004-294799. In Japanese Unexamined Patent Application Publication No. 11-264970, an opening such as a slit is disposed on a portion adjacent to the sealing material, of the resin BM so that the substrate and sealing material are directly bonded together with no resin BM therebetween. Similarly, in Japanese Unexamined Patent Application Publication No. 2004-294799, openings are disposed at the corners of a portion adjacent to the sealing material, of the resin BM so that the substrate and sealing material are directly bonded together with no resin BM therebetween.

As described above, the object of the related-art methods disclosed in Japanese Unexamined Patent Application Publication Nos. 11-264970 and 2004-294799 are to solve the substrate-peel-off or moisture-penetration problem caused by peel-off of the black matrix.

However, the moisture-resistant problem with liquid crystal display devices using a resin BM has been found to be actually caused not only by peel-off of the substrate but also by moisture coming through the portion of the resin BM interposed between the sealing material and substrate. Specifically, with a lapse of time, the resin BM absorbs moisture through its portion in contact with outside air, and the moisture then penetrates even the display area.

In Japanese Unexamined Patent Application Publication Nos. 11-264970 and 2004-294799, the resin BM acting as the penetration path of moisture from the outside remains between the sealing material and substrate, and the sealing material filling the openings made on the resin BM is simply intended to prevent peel-off of the substrate. Accordingly, these related-art examples are not optimized for preventing penetration of moisture. We have now discovered that these related-art methods cannot sufficiently solve the problem caused to the liquid crystal display device by penetration of moisture and rather they reduce yield or reliability.

In light of the foregoing, it is desirable to provide a liquid crystal display device of excellent display quality.

### SUMMARY OF THE INVENTION

An exemplary aspect of the present invention is a liquid crystal display device that includes a liquid crystal display panel having a first substrate and a second substrate disposed as opposed to the first substrate. The first substrate and the second substrate are bonded each other with a frame-shaped sealing material formed therebetween in a manner surrounding a display area. The liquid crystal display device further includes a frame-shaped resin black matrix formed to surround the display area on the second substrate and having a slit formed in a manner surrounding the display area, a moisture-resistant material formed to fill at least inside of the slit and having a water absorption ratio lower than a water absorption ratio of the sealing material, and liquid crystal filled in space formed by the first substrate, the second substrate, and the sealing material. The sealing material is disposed in a manner being inner than the slit. The sealing material is disposed in a manner extending to an outer end of a portion inner than the slit, of the resin black matrix, or the moisture-resistant material is disposed in a manner further covering a portion outer than an outer end of the sealing material, of a portion inner than the slit, of the resin black matrix.

According to the exemplary aspect of the present invention described above, it is possible to provide a liquid crystal display device of excellent display quality.

The above and other objects, features and advantages of the present invention will become more fully understood from the detailed description given hereinbelow and the accompanying drawings which are given by way of illustration only, and thus are not to be considered as limiting the present invention.

### BRIEF DESCRIPTION OF THE DRAWINGS

FIG. 1 is a front view showing the configuration of the liquid crystal display device according to a first exemplary embodiment;

FIG. 2 is a plan view schematically showing the configuration of the vicinity of the sealed area of the liquid crystal display device according to the first exemplary embodiment;

FIG. 3 is a sectional view taken along line III-III of FIG. 2;

FIG. 4 is a plan view schematically showing the configuration of the vicinity of the sealed area of the liquid crystal display device according to a second exemplary embodiment;

FIG. 5 is a sectional view taken along line V-V of FIG. 4;

FIG. 6 is a plan view schematically showing the configuration of the vicinity of the sealed area of the liquid crystal display device according to the third exemplary embodiment;

FIG. 7 is a sectional view taken along line VII-VII of FIG. 6;

FIG. 8 is a plan view schematically showing the configuration of the vicinity of the sealed area of a liquid crystal display device according to a modification of the third exemplary embodiment;

FIG. 9 is a sectional view taken along line IX-IX of FIG. 8;

FIG. 10 is a plan view schematically showing the configuration of the vicinity of the sealed area of the liquid crystal display device according to a fourth exemplary embodiment;

FIG. 11 is a sectional view taken along line XI-XI of FIG. 10; and

FIG. 12 is a sectional view schematically showing the configuration of the vicinity of the sealed area of a liquid crystal display device according to a modification of the fourth exemplary embodiment.

### DESCRIPTION OF THE EXEMPLARY EMBODIMENTS

Now, exemplary embodiments of the present invention will be described with reference to the accompanying drawings. To provide a clear understanding thereof, the exemplary embodiments will be described below or illustrated in the drawings in a partially omitted or simplified manner as appropriate. Also, overlapping description will be omitted as necessary. Same elements are given same reference numerals in the drawings and the description thereof will be omitted as appropriate.

### First Exemplary Embodiment

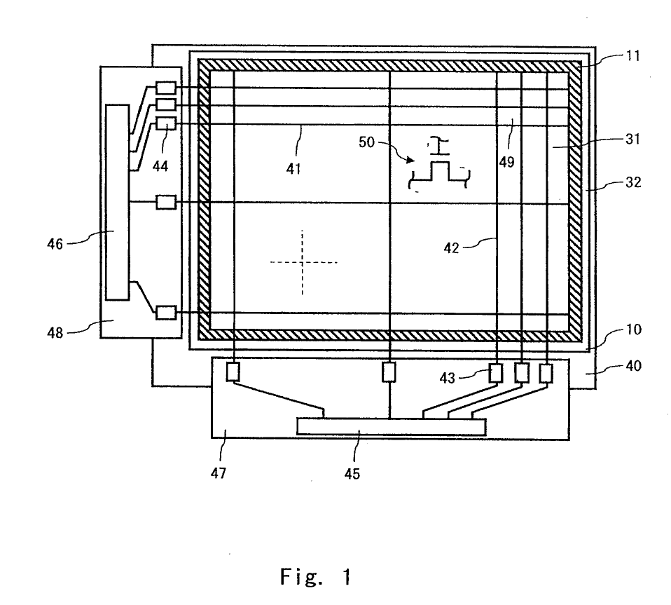

First, referring to FIG. 1, a liquid crystal display device according to a first exemplary embodiment of the present invention will be described. FIG. 1 is a front view showing the configuration of the liquid crystal display device according to the first exemplary embodiment. While the liquid crystal display device according to this exemplary embodiment will be described using an active-matrix liquid crystal display device including TFTs as an example, switching elements other than TFTs may be used. Alternatively, a passive-matrix liquid crystal display device may be used. The overall configuration of the liquid crystal display device is common to the first to fourth exemplary embodiments described below.

In FIG. 1, the liquid crystal display device according to this exemplary embodiment includes a liquid crystal display panel. In the liquid crystal display panel, a first substrate, TFT array substrate 40, and a second substrate, counter substrate 10, are disposed as opposed to each other.

The TFT array substrate 40 includes a display area 31 and a frame area 32 surrounding the display area 31. In the display area 31, a plurality of gate lines (scanning signal lines) 41 and a plurality of source lines (display signal lines) 42 are placed. The plurality of gate lines 41 are arranged in parallel with each other. Likewise, the plurality of source lines 42 are arranged in parallel with each other. The gate lines 41 and the source lines 42 are arranged to intersect with each other. The gate lines 41 and the source lines 42 are orthogonal with each other. Each area surrounded by the adjacent gate lines 41 and the adjacent source lines 42 is a pixel 49. Thus, the pixels 49 are arranged in matrix in the display area 31.

Connected to a frame area 32 of the TFT array substrate 40 are flexible substrates 47 and 48 having control circuits 45 and 46, respectively, mounted thereon. Gate lines 41 extend from the display area 31 to the frame area 32. The gate lines 41 are connected to the control circuit 46 via gate terminals 44 at an edge of the TFT array substrate 40. Likewise, source lines 42 extend from the display area 31 to the frame area 32. The source lines 42 are connected to the control circuit 45 via source terminals 43 at an edge of the TFT array substrate 40.

Various kinds of external signals are supplied to the control circuits 45 and 46. The control circuit 45 supplies a gate signal (scanning signal) to the gate lines 41 according to an external control signal. In response to the gate signal, the gate lines 41 are sequentially selected. On the other hand, the control circuit 46 supplies a display signal to the source lines 41 according to an external control signal or display data. A display voltage corresponding to the display data can be thereby supplied to the respective pixels 49.

In each pixel 49, at least one TFT 50 is formed. The TFT 50 is placed in the vicinity of an intersection of the source line 42 with the gate line 41. For example, this TFT 50 supplies the display voltage to a pixel electrode. Specifically, the TFT 50, which is a switching element, is turned on in accordance with the gate signal from the gate line 41. The display voltage is thereby applied from the source line 42 to the pixel electrode connected to a drain electrode of the TFT 50. Then, an electric field corresponding to the display voltage is generated between the pixel electrode and a counter electrode. Note that an alignment layer (not shown) is formed on the surface of the TFT array substrate 40.

On the other hand, the counter substrate 10 is, for example, a color filter substrate and is disposed on the viewing side. Formed on the surface opposed to the TFT array substrate 40, of the counter substrate 10 is a light-shielding black matrix (BM) 11. Although not shown, the black matrix 11 is disposed on the display area 31 in a grid pattern in a manner surrounding each of pixels 49 (not shown). The black matrix 11 is formed of a resin black matrix (resin BM) where a carbon black pigment or titanium black pigment is dispersed in an acrylic resin. A portion of the BM 11 is disposed on the frame area 32 in a manner surrounding the display area 31. In this exemplary embodiment, a slit is formed on the portion on the frame area 32, of the BM 11 in a manner surrounding the display area 31. Details will be described later.

A coloring layer composed of pigments or dyes is formed in a manner filling the area surrounded by the portion of the BM 11. The coloring layer is, for example, a color filter consisting of red (R), green (G), and blue (B). A counter electrode composed of a transparent conductive film such as indium tin oxide (ITO) is formed on approximately a whole surface of the display area 31. The counter electrode generates an electric field with pixel electrodes of the TFT array substrate 40 to drive the liquid crystal. The counter electrode is electrically connected to a transfer electrode disposed on the TFT array substrate 40 with a transfer material therebetween. Signals inputted from the outside via the transfer electrode and transfer material are transmitted to the counter electrode. Formed on the counter substrate 10 is an alignment layer for aligning the liquid crystal.

The TFT array substrate 40 and counter substrate 10 are bonded together with a sealing material (not shown) therebetween. The frame-shaped sealing material is formed in a manner surrounding the display area 31 and will be detailed later. Interposed between the TFT array substrate 40 and counter substrate 10 is a liquid crystal layer. That is, the liquid crystal is introduced between the TFT array substrate 40 and counter substrate 10. Polarizing plates, retardation films, and the like are disposed on the external surfaces of the TFT array substrate 40 and counter substrate 10. A backlight unit or the like is disposed on the non-viewing side, of the liquid crystal display panel.

The liquid crystals are driven by an electric field between the pixel electrode and the counter electrode. Specifically, the orientation of the liquid crystals between the substrates is changed. The polarization state of light passing through the liquid crystal layer is thereby changed. Specifically, the polarization state of light that has been linearly polarized through the polarizing plate is changed by the liquid crystal layer. To be more precise, light from the backlight unit becomes linearly polarized light by the polarizing plate on the TFT array substrate 40 side. The linearly polarized light then passes through the liquid crystal layer, thereby changing its polarization state.

Therefore, the amount of light passing through the polarizing plate on the counter substrate 20 side varies depending on the polarization state. Specifically, the amount of light passing through the polarizing plate on the viewing side, among light from the backlight unit which is transmitted through the liquid crystal display panel, varies. The orientation of the liquid crystals varies depending on a display voltage to be applied. Thus, the amount of light passing through the polarizing plate on the viewing side can be changed by controlling the display voltage. Specifically, a desired image can be displayed by varying the display voltage for each pixel.

The liquid crystal display device can use twisted nematic (TN) mode, super-twisted nematic (STN) mode, ferroelectric liquid crystal mode, or the like as its operation mode. The liquid crystal display device may be a liquid crystal display device employing an in-plane electric field system, such as in-plane switching (IPS) mode or fringe field switching (FFS) mode, where the counter electrode is disposed on the TFT array substrate 40 rather than on the counter substrate 10 and applies an electric field to the liquid crystal with the pixel electrodes in plane. In using a liquid crystal display panel employing an in-plane electric field system, slight changes, such as disposing of an overcoat film rather than the counter electrode on the coloring layer and BM on the counter substrate 10, must be made to the configuration of minor parts of this exemplary embodiment.

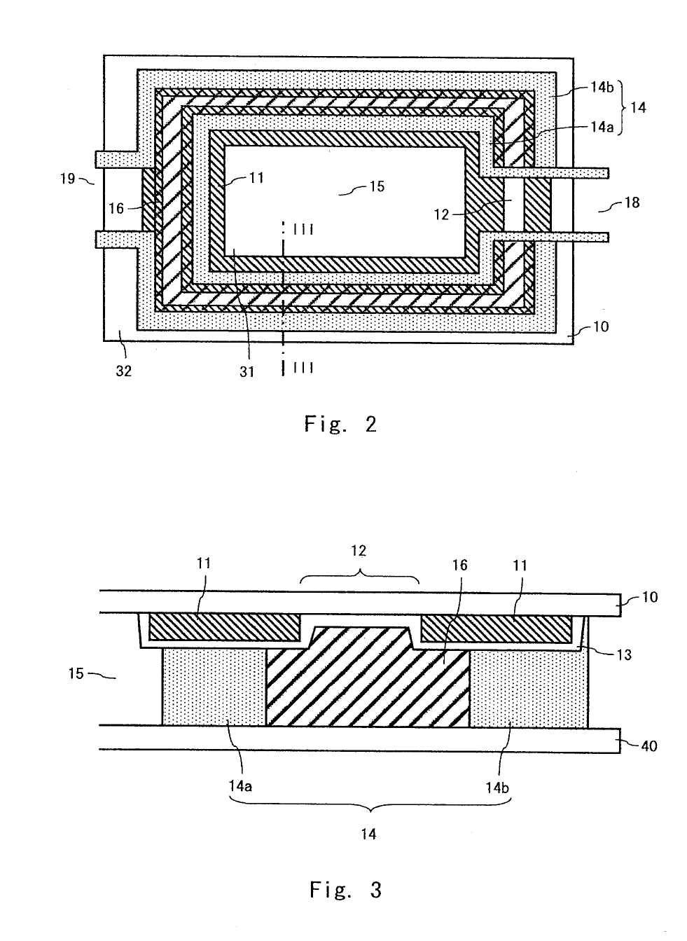

Next, the configuration of the sealed area will be described in detail with reference to FIGS. 2 and 3. FIG. 2 is a plan view schematically showing the configuration of the vicinity of the sealed area of the liquid crystal display device according to the first exemplary embodiment. FIG. 3 is a sectional view taken along line III-III of FIG. 2. For the sake of convenience, FIG. 2 shows the configuration of the liquid crystal display panel seen from above the TFT array substrate 40 as if the TFT array substrate 40 were transparent.

In FIGS. 2 and 3, the frame-shaped portion of the BM 11 is disposed on the frame area 32 on the counter substrate 10 in a manner surrounding the display area 31. As described above, the BM 11 is formed of a resin BM and has a slit-shaped opening (slit 12) formed in a manner surrounding the display area 31. Such disposition of the slit 12 completely separates the portion inner than the slit 12, of the BM 11 from the portion thereof outer than the slit 12. Accordingly, the portion inner than the slit 12, of the BM 11 and that outer than the slit 12 are separated each other and show different patterns. Further, a counter electrode 20 is formed on the counter substrate 10. The counter electrode 20 is formed in a manner covering the BM 11 and coloring layer having predetermined color arrangements disposed in the pixels 49 in the display area 31.

The counter substrate 10 is bonded to the TFT array substrate 40 with a sealing material 14 therebetween. The sealing material 14 may be made of, for example, an acrylic or epoxy resin having a photo-curable or thermosetting property or an ultraviolet curable resin. In order to keep constant the gap between the counter substrate 10 and TFT array substrate 40, the sealing material 14 contains spacers composed of, for example, microrods. In this exemplary embodiment, the sealing material 14 is disposed doubly in a manner surrounding the display area 31. Specifically, the sealing material 14 consists of a frame-shaped first sealing material 14a and a frame-shaped second sealing material 14b. The first sealing material 14a is formed in such a manner that it is inner than the slit 12 and surrounds the display area 31. The second sealing material 14b is formed in such a manner that it is outer than the slit 12 and surrounds the display area 31. Alignment layers (not shown) for aligning the liquid crystal are formed on the respective surfaces opposed to the liquid crystal 15, of the counter substrate 10 and TFT array substrate 40. The first sealing material 14a has an injection port (liquid crystal injection port) 18 through which the liquid crystal 15 is injected. The first sealing material 14a is formed in a manner being inner than the slit 12 of the BM 11, except for the portion thereof constituting the injection port 18. Specifically, the frame-shaped portion of the first sealing material 14a is disposed on an inward side with respect to an outer end of the BM 11 which is inner than and adjacent to the slit 12. The injection port 18 is made on, for example, a shorter side of the liquid crystal display panel. In FIG. 2, the injection port 18 is made on the right side of the liquid crystal display panel. The space formed by the first sealing material 14a, the counter substrate 10, and the TFT array substrate 40 is filled with the liquid crystal 15.

On the other hand, the frame-shaped second sealing material 14b is formed in a manner being outer than the first sealing material 14a and has an injection port (moisture-resistant material injection port) 19 through which a moisture-resistant material 16 is injected. The second sealing material 14b is disposed in a manner being outer than the slit 12 of the BM 11. That is, the second sealing material 14b is formed on an outward side with respect to an inner end of the BM11 which is outer than and adjacent to the slit 12. As shown in FIGS. 2 and 3, the second sealing material 14b may be formed in a manner straddling an outer end outer than the slit 12, of the BM 11. In other words, the outer end of the BM 11 outer than the slit 12 may be covered by the second sealing material 14b. The second sealing material 14b is formed as connected to the portion constituting the injection port 18, of the first sealing material 14a, rather than being formed inside the injection port 18.

The injection port 19 is made on, for example, the side of the liquid crystal display panel opposite to the side thereof having the injection port 18. In FIG. 2, the injection port 19 is made on the left side of the liquid crystal display panel. As seen, the injection port 19 of the second sealing material 14b is disposed in a manner being opposite to the injection port 18 of the first sealing material 14a, so the injection ports do not readily interfere with each other in the injection step. This can facilitate the injection process. The disposition of the injection ports 18 and 19 is not limited to the above-mentioned positions and these injection ports may be disposed on the same side of the liquid crystal display panel or adjacent sides thereof.

In this exemplary embodiment, the space formed by the first sealing material 14a, the second sealing material 14b, the counter substrate 10, and the TFT array substrate is filled with the moisture-resistant material 16 having a water absorption ratio lower than that of the sealing material 14. The slit 12 is configured to be covered by the moisture-resistant material 16. Accordingly, the slit 12 of the BM 11 are filled with the moisture-resistant material 16. The moisture-resistant material 16 is made of a resin more moisture-resistant, that is, less water-absorptive than at least the resin constituting the sealing material 14. The moisture-resistant material 16 may be made of, for example, an ultraviolet curable or thermosetting resin. The moisture-resistant material 16 may be a commercially available moisture-resistant resin and, as the index of the low water absorbing property, its water absorption ratio at room temperature is preferably 2% or less. Examples of such a resin include phenol resins containing allyl ether groups and resins containing an ethylene-vinyl acetate resin as the main ingredient.

The moisture-resistant material 16 need not contribute to the bonding strength between the counter substrate 10 and the TFT array substrate 40 but is only required to meet the moisture-resistance requirement. So, it may be a soft resin such as an ethylene-vinyl acetate resin. Also, the moisture-resistant material 16 does not make contact with the liquid crystal 15 unlike the resin used in the sealing material 14, so there is no need to be concerned that its resin components may affect the properties of the liquid crystal 15. Accordingly, an additive or the like may be freely used as the moisture-resistant material 16 while focusing on an improvement in moisture resistance.

In the liquid crystal display device thus configured, the inside and outside patterns of the BM 11 are completely separated from each other with the slit 12 therebetween. This can prevent moisture coming from the outside through the portion of the BM 11 from reaching the liquid crystal 15. That is, the slit 12 can block the penetration path of moisture attempting to reach the liquid crystal 15 through the BM 11. Further, the moisture-resistant material 16 disposed in the slit 12 can suppress penetration of moisture coming through the portion outer than the slit 12, of the BM 11 into the portion inner than the slit 12, of the BM 11 or between the BM 11 and the first sealing material 14a.

Incidentally, for the configuration where the transfer unit is disposed outside the sealing material 14, there is a concern that the step height between the slit 12 and black matrix 11 may cause disconnection of the counter electrode 20. Accordingly, in terms of reliability, it is preferable that the end surface of the BM 11 be gently tapered toward the substrate. This can prevent disconnection of the counter electrode 20 on the portion thereof straddling the slit 12.

Next, a method for manufacturing the liquid crystal display device according to the first exemplary embodiment will be described. First, the gate lines 41, the source lines 42, the TFTs 50, the pixel electrodes, and the like are formed on a substrate made of optically transparent glass or the like to form the TFT array substrate 40.

The BM 11, the coloring layer, the counter electrode, and the like are formed on another substrate to form the counter substrate 10. In this exemplary embodiment, the BM 11 is made of a resin black matrix by photolithography and wet etching. At that time, the frame-shaped BM 11 is formed on the frame area 32 in a manner surrounding the display area 31. Also, the slit 12 is made on the frame-shaped BM in a manner surrounding the display area 31.

Subsequently, alignment layers are formed on the TFT array substrate 40 and the counter substrate 10. The formed alignment layers are then rubbed to provide them with a function of aligning liquid crystal molecules.

Subsequently, the sealing material 14 is applied to one of the TFT array substrate 40 and the counter substrate 10. The sealing material 14 is formed by way of screen printing, a dispenser, or the like. In this exemplary embodiment, the sealing material 14 is disposed doubly on the frame area 32 by forming the first sealing material 14a and second sealing material 14b. A transfer material is then applied to one of the TFT array substrate 41 and the counter substrate 10. The TFT array substrate 40 and the counter substrate 10 are then opposed to each other and bonded together so that the pixel electrodes on the TFT array substrate 40 and the counter electrode 20 on the counter substrate 10 are opposed to each other. The sealing material 14 is then cured with both substrates bonded together.

In applying the sealing material 14 to, for example, the counter substrate 10, the first sealing material 14a and the second sealing material 14b are formed in a manner being inner than the slit 12 and in a manner being outer than the slit 12, respectively, and the counter substrate 10 is then bonded to the TFT array substrate 40. Alternatively, in applying the sealing material 14 to the TFT array substrate 40, it is preferable that the first sealing material 14a and second sealing material 14b be formed at a predetermined interval and the counter substrate 10 be then bonded to the TFT array substrate 40 so that the slit 12 is disposed between these sealing materials.

Subsequently, the liquid crystal 15 is introduced. Specifically, the injection port 18 of the liquid crystal display panel is immersed with a liquid crystal material contained in a liquid crystal plate under vacuum and normal pressure is then restored. Thus, the space surrounded by the first sealing material 14a, the counter substrate 10, and the TFT array substrate 40 is filled with the liquid crystal material. The injection port 18 is then sealed. Specifically, the injection port 18 is sealed, for example, by applying a photo-curable resin to the injection port 18 and curing the resin through application of light.

Subsequently, the previously-prepared moisture-resistant material 16 is introduced. Specifically, the injection port 19 of the liquid crystal display panel is immersed with the moisture-resistant material 16 contained in a plate under vacuum and normal pressure is then restored. Thus, the space surrounded by the first sealing material 14a, the second sealing material 14b, the counter substrate 10, and the TFT array substrate 40 is filled with the moisture-resistant material 16. The moisture-resistant material 16 is then cured using a method according to the properties of the moisture-resistant material 16, for example, by heating or ultraviolet (UV) irradiation.

Subsequently, polarizing plates are bonded to both external surfaces of the liquid crystal display panel. The flexible substrates 48 and 49a are mounted and backlight unit and the like are then attached on the liquid crystal display panel, thereby completing the liquid crystal display device according to this exemplary embodiment.

As seen, in the first exemplary embodiment, the slit 12 is formed on the frame-shaped portion surrounding the display area 31, of the resin BM 11 in a manner surrounding the display area 31, and the sealing material 14 is disposed doubly, one inner than the slit 12 and the other outer than the slit 12. Subsequently, the moisture-resistant material 16 is introduced between the doubly disposed sealing material 14 so that it fills the slit 12 and covers the outer end of the BM 11 inner than the slit 12 and the inner end of the BM 11 outer than the slit 12. This can prevent further penetration of moisture coming through the portion of the BM 11. Specifically, further penetration of moisture coming through the portion outer than the slit 12, of the BM 11 into the portion inner than the slit 12, of the BM 11 or between the BM 11 and the first sealing material 14a can be suppressed. This can suppress penetration of moisture into the liquid crystal 15, thereby suppressing occurrence of problems such as display unevenness. Accordingly, a liquid crystal display device of excellent display quality can be obtained so that yield or reliability can be increased.

In this exemplary embodiment, the moisture-resistant material 16 is formed in a manner covering the slit 12, but not limited thereto. Specifically, as long as the moisture-resistant material 16 is formed in a manner filling at least inside of the slit 12 and the portion inner than the slit 12, of the BM 11 and that outer than the slit 12 are completely separated from each other by the space surrounded by the moisture-resistant material 16, the counter substrate 10, and the TFT array substrate 40, the moisture-resistant material 16 need not necessarily cover the inner end of the BM 11 outer than the slit 12. Also, the moisture-resistant material 16 need not necessarily cover the outer end of the BM 11 inner than the slit 12 and, even so, the same advantages as the above-mentioned ones can be obtained.

In this case, the second sealing material 14b is preferably disposed so that its inner end is located in a position identical to or on an outward side with respect to the outer end of the slit 12. Also, the first sealing material 14a is preferably disposed so that its outer end is located in a position identical to or on an inward side with respect to the inner end of the slit 12. In other words, the first sealing material 14a is preferably disposed in a manner extending to the outer end inner than and adjacent to the slit 12, of the BM 11 or the moisture-resistant material 16 is preferably disposed in a manner further covering the portion outer than the outer end of the first sealing material 14a, of the portion inner than the slit 12 of the BM 11.

Also, as long as the moisture-resistant material 16 is disposed in a manner covering at least the outer end and surface of the portion not covered by the first sealing material 14a, of the portion inner than the slit 12 of the BM 11, the moisture-resistant material 16 need not completely fill the space surrounded by the doubly disposed sealing material 14, the counter substrate 10, and the TFT array substrate 40. Note that, by forming the moisture-resistant material 16 in such a manner that it not only covers the outer end and surface of the portion not covered by the first sealing material 14a, of the portion inner than the slit 12, of the BM 11 but also completely covers the outer end of the first sealing material 14a as in this exemplary embodiment, penetration of moisture into the liquid crystal 15 can be effectively suppressed. Similarly, by disposing the moisture-resistant material 16 in such a manner that it not only covers the inward end and surface of the portion not covered by the second sealing material 14b, of the portion outer than the slit 12 of the BM 11 but also covers the inner end of the second sealing material 14b, penetration of moisture into the liquid crystal 15 can be effectively suppressed.

### Second Exemplary Embodiment

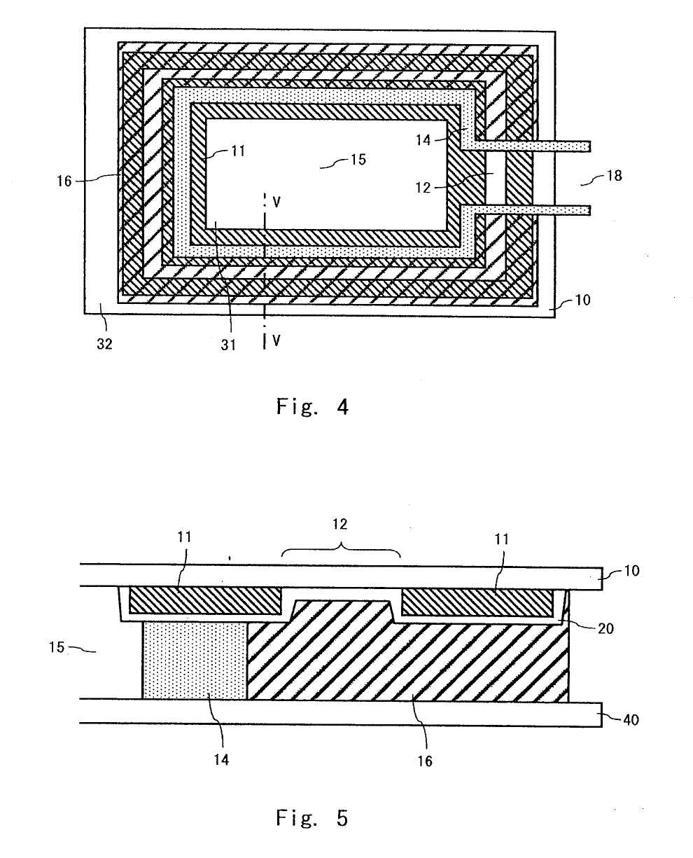

The configuration of the sealed area of a liquid crystal display device according to a second exemplary embodiment of the present invention will be described with reference to FIGS. 4 and 5. FIG. 4 is a plan view schematically showing the configuration of the vicinity of the sealed area of the liquid crystal display device according to the second exemplary embodiment. FIG. 5 is a sectional view taken along line V-V of FIG. 4. As with FIG. 2, for the sake of convenience, FIG. 4 shows the configuration of the liquid crystal display panel seen from above the TFT array substrate 40 as if the TFT array substrate 40 were transparent.

As shown in FIGS. 4 and 5, the frame-shaped sealing material 14 is formed in a manner being inner than the slit 12 and surrounding the display area 31. Although in the first exemplary embodiment, the sealing material 14 is formed doubly, one inner than the slit 12 and the other outer than the slit 12; in this exemplary embodiment, the sealing material 14 is not disposed in a manner being outer than the slit 12, that is, the sealing material 14 is not doubly disposed. As seen, as long as the sealing material 14 is formed in a manner being inner than the slit 12 and surrounding the display area 31, another sealing material 14 need not be formed in a manner being outer than the slit 12.

The TFT array substrate 40 and the counter substrate 10 are bonded together with the sealing material 14 disposed in such a position therebetween and the liquid crystal 15 is then introduced into the liquid crystal display panel. Subsequently, the moisture-resistant material 16 is introduced into all the sides of the liquid crystal display panel using a capillary phenomenon. The moisture-resistant material 16 is then introduced into the space formed by the outer end of the sealing material 14, the counter substrate 10, and TFT array substrate 40. Subsequently, as in the first exemplary embodiment, where the sealing material 14 is doubly disposed, the moisture-resistant material 16 is formed in a manner filling at least inside of the slit 12. The elements other than the sealing material 14 and moisture-resistant material 16 are the same as those in FIGS. 2 and 3 and will not be described.

As seen, in this exemplary embodiment, the slit 12 is formed on the frame-shaped resin BM 11 surrounding the display area 31 in a manner surrounding the display area 31, and the sealing material 14 is disposed in a manner being inner than the slit 12. The moisture-resistant material 16 is introduced into the space outer than the sealing material 14 and the moisture-resistant material 16 fills at least inside of the slit 12. The sealing material 14 is disposed in a manner extending to the outer end of the portion inner than the slit 12, of the BM 11 or the moisture-resistant material 16 is disposed in a manner further covering the portion outer than the outer end of the sealing material 14, of the portion inner than the slit 12, of the BM 11. Thus, advantages similar to those of the first exemplary embodiment can be obtained. That is, further penetration of moisture coming through the portion of the BM 11 can be suppressed. Specifically, further penetration of moisture coming through the portion outer than the slit 12, of the BM 11 into the portion inner than the slit 12, of the BM 11 or between the BM 11 and the sealing material 14 can be suppressed. This can suppress penetration of moisture into the liquid crystal 15, suppressing occurrence of problems such as display unevenness. Thus, a liquid crystal display device of excellent display quality can be obtained so that yield or reliability can be increased.

If the moisture-resistant material 16 is disposed in a manner further covering the outer end of the portion inner than the slit 12, of the BM 11, as in the first exemplary embodiment, that is, if the moisture-resistant material 16 is disposed in a manner further covering the portion outer than the outer end of the sealing material 14, of the portion inner than the slit 12, of the BM 11, penetration of moisture into the liquid crystal 15 can be more effectively suppressed. Also, if the moisture-resistant material 16 is disposed in a manner further covering the inner end of the portion outer than the slit 12, of the BM 11, penetration of moisture into the liquid crystal 15 can be more effectively suppressed.

In this exemplary embodiment, the moisture-resistant material 16 is more preferably disposed in a manner further covering the outer end of the portion outer than the slit 12, of the BM 11. Specifically, the moisture-resistant material 16 is preferably introduced so that, after cured, the moisture-resistant material 16 covers the outer end of the portion outer than the slit 12, of the BM 11, as shown in FIGS. 4 and 5. Thus, the area of the BM 11 from the outer end of the portion thereof inner than the slit 12 to the outer end of the portion thereof outer than the slit 12 is covered by the moisture-resistant material 16. This can suppress penetration of moisture into the portion outer than the slit 12, of the BM 11, thereby more effectively suppressing penetration of moisture into the liquid crystal 15.

### Third Exemplary Embodiment

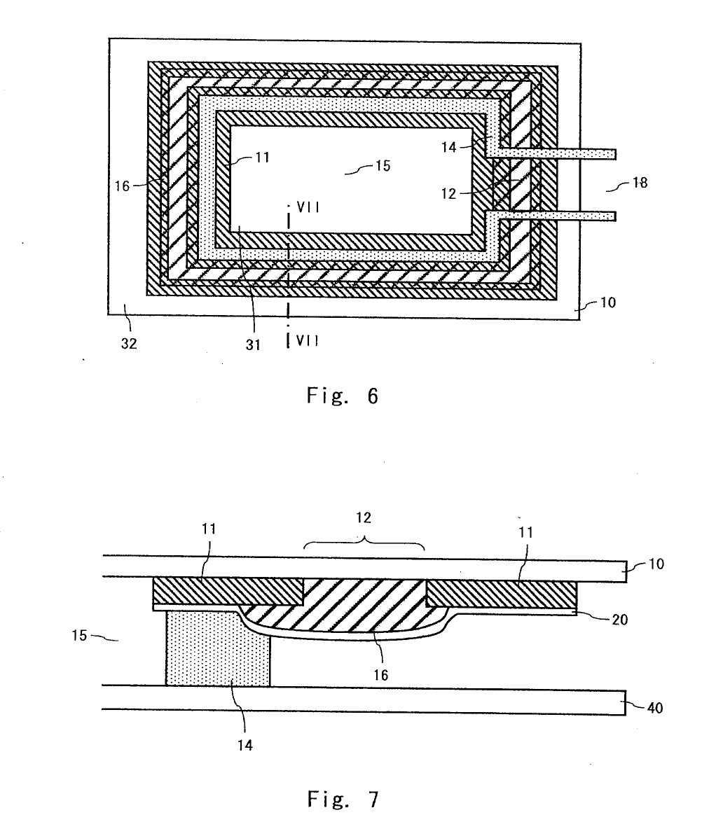

A configuration of the sealed area of a liquid crystal display device according to a third exemplary embodiment of the present invention will be described with reference to FIGS. 6 and 7. FIG. 6 is a plan view schematically showing the configuration of the vicinity of the sealed area of the liquid crystal display device according to the third exemplary embodiment. FIG. 7 is a sectional view taken along line VII-VII of FIG. 6. As with FIGS. 2 and 4, for the sake of convenience, FIG. 6 shows the configuration of the liquid crystal display panel seen from above the TFT array substrate 40 as if the TFT array substrate 40 were transparent.

In the first and second exemplary embodiments, the moisture-resistant material 16 is introduced between the TFT array substrate 40 and the counter substrate 10 by filling method; in the third exemplary embodiment, a case where the moisture-resistant material 16 is formed on the counter substrate 10 will be described.

As shown in FIGS. 6 and 7, in the third exemplary embodiment, the moisture-resistant material 16 is formed on the counter substrate 10. The moisture-resistant material 16 is formed in a manner filling at least inside of the slit 12 of the BM 11. For example, in FIGS. 6 and 7, the moisture-resistant material 16 is disposed in a manner further covering the outer end of the portion inner than the slit 12, of the BM 11 and the inner end of the portion outer than the slit 12, of the BM 11.

As in the first and second exemplary embodiments, the moisture-resistant material 16 to be used in this exemplary embodiment is a material more moisture-resistant than at least the BM 11, that is, a material having a water absorption ratio lower than the sealing material 14. For example, a material capable of making a pattern by normal photolithography, such as SiO₂ or TiO₂, may be used as the moisture-resistant material 16. Alternatively, a thermosetting or photo-curable resin may be used as the moisture-resistant material 16. Alternatively, the moisture-resistant material 16 may be a moisture-resistant sealant.

Further, the counter electrode 20 is formed on these elements. The counter electrode 20 is formed in a manner covering the BM 11, the moisture-resistant material 16, and the coloring layer disposed inside the display area 31.

The counter substrate 10 thus configured is bonded to the TFT array substrate 40 with the sealing material 14 therebetween. The frame-shaped sealing material 14 is formed in a manner being inner than the slit 12 and surrounding the display area 31. In this exemplary embodiment, the sealing material 14 is disposed in a manner overlapping the moisture-resistant material 16. Specifically, the sealing material 14 is disposed in such a manner that it straddles the inner end of the moisture-resistant material 16 to overlap the moisture-resistant material 16. Thus, the portion outer than the inner end of the sealing material 14, of the portion inner than the slit 12, of the BM 11 is always covered by one of the sealing material 14 and the moisture-resistant material 16. The elements other than the moisture-resistant material 16 and sealing material 14 are the same as those in FIG. 2 and will not be described.

For the liquid crystal display device thus configured, the moisture-resistant material 16 is preferably formed in the step of forming the counter substrate 10, instead of filling the moisture-resistant material 16 after filling the liquid crystal 15 as in the first and second exemplary embodiments. Specifically, after forming the BM 11 or the coloring layer, the moisture-resistant material 16 is formed in a manner filling at least inside of the slit 12. The moisture-resistant material 16 may be formed by known photolithography. Subsequently, the counter electrode 20 is formed on the BM 11, the moisture-resistant material 16, and the coloring layer. The counter substrate 10 is then bonded to the separately manufactured TFT array substrate 40 with the sealing material 14, located in a position straddling the inner end of the moisture-resistant material 16, interposed therebetween. The other steps are the same as those in the first and second exemplary embodiments.

As seen, in this exemplary embodiment, the slit 12 is formed on the frame-shaped portion of the resin BM 11 surrounding the display area 31 in a manner surrounding the display area 31, and the moisture-resistant material 16 is formed on the counter substrate 10 in a manner filling at least inside of the slit 12. The sealing material 14 is disposed in such a manner that it straddles the inner end of the slit 12 to overlap the moisture-resistant material 16. Thus, advantages similar to those of the first and second exemplary embodiments can be obtained. That is, further penetration of moisture coming through the portion of the BM 11 can be suppressed. Specifically, further penetration of moisture coming through the portion outer than the slit 12, of the BM 11 into the portion inner than the slit 12, of the BM 11 or between the BM 11 and the sealing material 14 can be suppressed. This can suppress penetration of moisture into the liquid crystal 15, thereby suppressing occurrence of problems such as display unevenness. Accordingly, a liquid crystal display device of excellent display quality can be obtained so that yield or reliability can be increased.

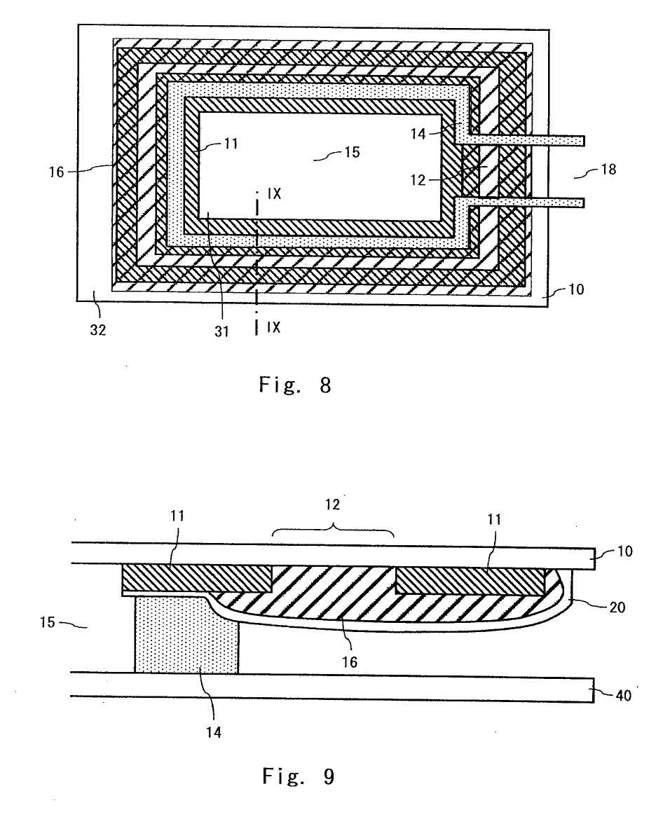

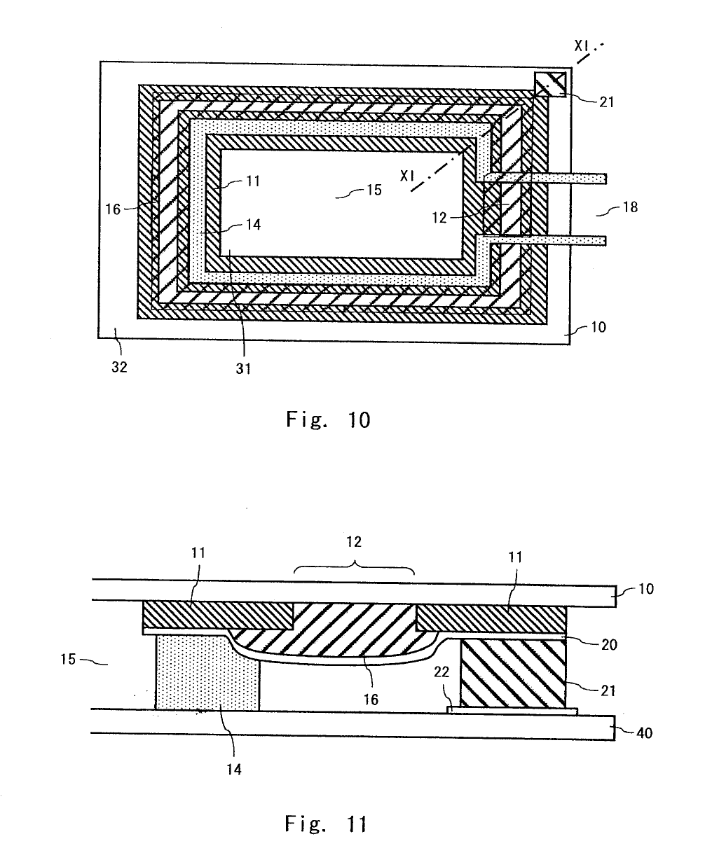

In FIGS. 6 and 7, the moisture-resistant material 16 is disposed in a manner covering the outer end of the portion inner than the slit 12, of the BM 11 and the inner end of the portion outer than the slit 12, of the BM 11; however, the area where the moisture-resistant material 16 is formed is not limited thereto. FIG. 8 is a plan view schematically showing the configuration of the vicinity of the sealed area of a liquid crystal display device according to a modification of the third exemplary embodiment. FIG. 9 is a sectional view taken along line IX-IX of FIG. 8. As with FIG. 2, for the sake of convenience, FIG. 8 shows the configuration of the liquid crystal display panel seen from above the TFT array substrate 40 as if the TFT array substrate 40 were transparent. As shown in FIGS. 8 and 9, the moisture-resistant material 16 may be disposed in a manner further covering the outer end of the portion outer than the slit 12, of the BM 11. Specifically, the area of the BM 11 from the outer end of the portion thereof inner than the slit 12 to the outer end of the portion thereof outer than the slit 12 may be covered by the moisture-resistant material 16. This can suppress penetration of moisture into the portion outer than the slit 12, of the BM 11. Accordingly, penetration of moisture into the liquid crystal 15 can be suppressed more effectively.

### Fourth Exemplary Embodiment

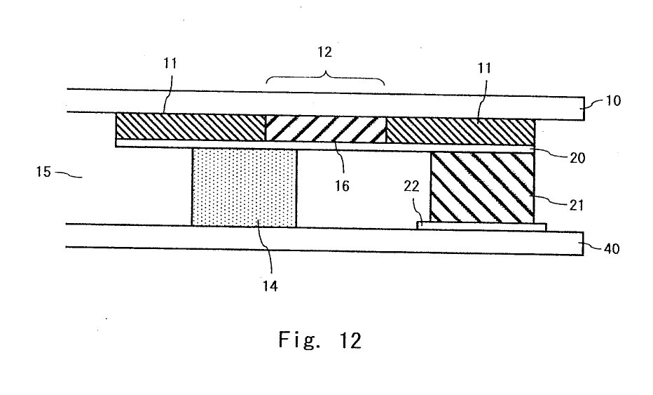

A configuration of the sealing area of a liquid crystal display device according to a fourth exemplary embodiment of the present invention will be described with reference to FIGS. 10 and 11. FIG. 10 is a plan view schematically showing the configuration of the vicinity of the sealed area of the liquid crystal display device according to the fourth exemplary embodiment. FIG. 11 is a sectional view taken along line XI-XI of FIG. 10. As with FIG. 2, for the sake of convenience, FIG. 10 shows the configuration of the liquid crystal display panel seen from above the TFT array substrate 40 as if the TFT array substrate 40 were transparent.

In this exemplary embodiment, a case will be described where the transfer portion is disposed in a manner being outer than the sealing material 14 in a configuration where the slit 12 is disposed on the frame-shaped portion of the BM 11 surrounding the display area 31 in a manner surrounding the display area 31. In the above-mentioned case, the counter electrode 20 may disconnect due to the step height between the slit 12 and the BM 11. For this reason, a case where the present invention is applied to prevent the counter electrode 20 from disconnecting on the slit 12 will be described below.

As shown in FIGS. 10 and 11, in this exemplary embodiment, the transfer portion for electrically connecting the counter substrate 10 and the TFT array substrate 40 is further disposed in a manner being outer than the sealing material 14. In the transfer portion, the counter electrode 20 is electrically connected to a transfer electrode 22 disposed on the TFT array substrate 40 with a transfer material 21 therebetween. The transfer portion is connected to the counter electrode 20 in a manner being outer than the slit 12.

In this exemplary embodiment, as in the third exemplary embodiment, the moisture-resistant material 16 is formed on the counter substrate 10. Specifically, the moisture-resistant material 16 is formed in a manner filling at least inside the slit 12 of the BM 11. For example, in FIGS. 10 and 11, the moisture-resistant material 16 is disposed in a manner further covering the outer end of the portion inner than the slit 12, of the BM 11 and the inner end of the portion outer than the slit 12, of the BM 11. Also, as in the third exemplary embodiment, the counter electrode 20 is formed in a manner covering the BM 11, the moisture-resistant material 16, and the coloring layer disposed inside the display area 31. The elements other than the transfer portion are the same as those in FIG. 3 and will not be described in detail.

As seen, the moisture-resistant material 16 is formed on the counter substrate 10 in a manner filling at least inside the slit 12 of the BM 11, so the step height between the slit 12 and the BM 11 can be reduced. This can prevent the counter electrode 20 from disconnecting on the portion straddling the slit 12. Accordingly, a liquid crystal display device of excellent display quality can be obtained so that yield or reliability can be increased.

In this exemplary embodiment, the moisture-resistant material 16 is preferably formed in such a manner that it smoothly covers the slit 12 to smooth the step height between the slit 12 and the BM 11. This can further reduce the step height between the slit 12 and BM 11. For example, as in FIGS. 10 and 11, the moisture-resistant material 16 may be disposed in a manner further covering the outer end of the portion inner than the slit 12, of the BM 11 and the inner end of the portion outer than the slit 12, of the BM 11. Even in this case, the moisture-resistant material 16 preferably has a smooth surface extending from the surface of the portion inner than the slit 12, of the BM 11 to the surface of the portion outer than the slit 12, of the BM 11.

Hereafter, a more preferable example will be described with reference to FIG. 12. FIG. 12 is a sectional view schematically showing the configuration of the vicinity of the sealed area of a liquid crystal display device according to a modification of the fourth exemplary embodiment. In FIG. 12, the moisture-resistant material 16 is formed with approximately the same film thickness as that of the BM 11 so as to smooth the step height between the slit 12 and the BM 11. This can roughly eliminate the step height between the moisture-resistant material 16 and the BM 11. Thus, disconnection of the counter electrode 20 on its portion straddling the slit 12 can be prevented more effectively. Incidentally, in the case where the moisture-resistant material 16 is formed with approximately the same thickness as that of the BM 11, the sealing material 14 is preferably disposed in such a manner that it straddles the inner end of the moisture-resistant material 16 filling inside of the slit 12 to overlap the moisture-resistant material 16, that is, in a manner extending from inside of the slit 12 to outside thereof. Thus, the outer end of the portion inner than the slit 12, of the BM 11 is covered by the sealing material 14 so that penetration of moisture can be prevented.

The present invention is not limited to the above-mentioned exemplary embodiments and changes can be made thereto as appropriate without departing from the spirit and scope of the invention. While the active-matrix liquid crystal display devices including TFTs are used in the first to fourth exemplary embodiments, switching elements other than TFTs may be used. Alternatively, passive-matrix liquid crystal display devices may be used. Instead of the above-mentioned methods, one drop filling may be employed to inject liquid crystal.

From the invention thus described, it will be obvious that the embodiments of the invention may be varied in many ways. Such variations are not to be regarded as a departure from the spirit and scope of the invention, and all such modifications as would be obvious to one skilled in the art are intended for inclusion within the scope of the following claims.

What is claimed is:

1. A liquid crystal display device comprising:
a liquid crystal display panel including a first substrate and a second substrate disposed as opposed to the first substrate, the first substrate and the second substrate bonded each other with a frame-shaped sealing material formed therebetween in a manner surrounding a display area;
a frame-shaped resin black matrix formed to surround the display area on the second substrate, the resin black matrix having a slit formed in a manner surrounding the display area;
a moisture-resistant material formed in a manner filling at least inside of the slit, the moisture-resistant material having a water absorption ratio lower than a water absorption ratio of the sealing material; and
liquid crystal filled in space formed by the first substrate, the second substrate, and the sealing material, wherein
the sealing material is disposed in a manner being inner than the slit, and
the sealing material is disposed in a manner extending to an outer end of a portion inner than the slit, of the resin black matrix, or the moisture-resistant material is disposed in a manner further covering a portion outer than an outer end of the sealing material, of a portion inner than the slit, of the resin black matrix.

2. The liquid crystal display device according to claim 1, wherein
the sealing material includes a frame-shaped first sealing material formed in a manner being inner than the slit and surrounding the display area and a frame-shaped second sealing material formed in a manner being outer than the slit and surrounding the display area, and
the moisture-resistant material is disposed in space formed by the first substrate, the second substrate, the first sealing material, and the second sealing material.

3. The liquid crystal display device according to claim 2, wherein
the sealing material has a liquid crystal injection port that is disposed on the first sealing material for filling the liquid crystal through and a moisture-resistant material injection port that is disposed on the second sealing material for filling the moisture-resistant material through, and
the moisture-resistant material injection port is disposed on a side of the liquid crystal display panel, the side being opposite to a side thereof on which the liquid crystal injection port is disposed.

4. The liquid crystal display device according to claim 1, wherein the moisture-resistant material is disposed in space, the space being outer than the sealing material and formed between the first substrate and the second substrate.

5. The liquid crystal display device according to claim 1, wherein
the moisture-resistant material is formed on the second substrate, and
the sealing material is disposed in such a manner that the sealing material straddles an inner end of the moisture-resistant material to overlap the moisture-resistant material.

6. The liquid crystal display device according to claim 5, further comprising:
a pixel electrode formed on the first substrate;
a counter electrode disposed on the second substrate in a manner covering the resin black matrix and the moisture-resistant material, the counter electrode driving the liquid crystal with the pixel electrode; and
a transfer portion that electrically connects the first substrate and the second substrate, wherein
the transfer portion is formed outer than the slit to be connected to the counter electrode.

7. The liquid crystal display device according to claim 6, wherein the moisture-resistant material covers the slit smoothly so as to smooth a step height between the slit and the resin black matrix.

8. The liquid crystal display device according to claim 1, wherein the moisture-resistant material is disposed in a manner further covering an inner end of a portion outer than the slit, of the resin black matrix.

9. The liquid crystal display device according to claim 8, wherein the moisture-resistant material is disposed in a manner further covering an outer end of the portion outer than the slit, of the resin black matrix.

10. The liquid crystal display device according to claim 6, wherein the moisture-resistant material is formed with approximately the same film thickness as a film thickness of the resin black matrix so as to smooth a step height between the slit and the resin black matrix.

11. The liquid crystal display device according to claim 10, wherein the sealing material is disposed in such a manner that the sealing material straddles the inner end of the moisture-resistant material filling inside of the slit so as to overlap the moisture-resistant material.
